(19) United States
(12) Patent Application Publication
(10) Pub. No.: US 2024/0329263 A1
(43) Pub. Date: Oct. 3, 2024

(54) SENSOR DEVICE FOR GEOPHYSICAL MEASUREMENT INTENDED TO BE DISPOSED ON A SURFACE OF A GROUND, RELATED ASSEMBLY AND METHOD FOR DEPLOYING AND RETRIEVING SUCH A SENSOR

(71) Applicant: TotalEnergies OneTech, COURBEVOIE (FR)

(72) Inventors: Jean-Luc BOELLE, PAU CEDEX (FR); Florent BERTINI, PAU CEDEX (FR)

(73) Assignee: TotalEnergies OneTech, COURBEVOIE (FR)

(21) Appl. No.: 18/578,993

(22) PCT Filed: Jul. 16, 2021
(86) PCT No.: PCT/IB2021/000483

§ 371 Date: Jan. 12, 2024

(51) Int. Cl. G01V 1/16; B64U 10/14; B64U 101/60; G01V 1/18

(52) U.S. Cl. CPC G01V 1/168; G01V 1/181; B64U 10/14; B64U 2101/60

(57) ABSTRACT

The present invention relates to a sensor device for geophysical measurement intended to be disposed on a surface of a ground, comprising:
a sealed enclosure deformable into at least one stable configuration in which a surface of the enclosure is deformed by a surface of the ground against which the surface of the enclosure is in contact, the enclosure being partially filled with a material configured to be deformed by said surface,
at least one geophysical sensor arranged inside the enclosure , and fully surrounded by the material or being fixed or printed on the surface of the enclosure intended to be in contact with the surface of the ground.

### CROSS REFERENCE TO RELATED APPLICATION

The present application is a U.S. National Phase Application under 35 U.S.C. § 371 of International Patent Application No. PCT/IB2021/000483 filed Jul. 16, 2021. The entire contents of which are hereby incorporated by reference.

### FIELD OF THE INVENTION

The present invention relates to a sensor device for geophysical measurement intended to be disposed on a surface of a ground.

Each sensor device is in particular intended to form a receiver including at least a seismic sensor to conduct a geophysical survey in a region of interest.

The region of interest is notably a region with a difficult access. The region in particular comprises rugged terrain such as hills (for example foothills), cliffs and/or mountains. The region of interest typically comprises rocky soil with only a thin topsoil layer or no layer of topsoil at all. In addition, the region may comprise dangerous to access areas, such as areas with unexploded ordinances (UXO's).

Typically, the region of interest is a non-forest environment, for example, a rocky desert or any open area.

The sensor can also be used in any region of interest.

### BACKGROUND

Geophysical measurements obtained during seismic surveys are critical in building a subsurface earth image representative of the particular geology in the region of interest, in particular to determine the location of potential reservoirs of oil and gas.

Such a geophysical survey is for example conducted by placing an array of seismic sources in the ground in the region of interest and by deploying seismic sensors able to record reflections of seismic signals produced by the successive sources on the different layers of the earth.

The survey generally requires implanting the sources at various locations, and partially introducing receivers in the ground along several lines to create a dense array of receivers.

The quality of the image obtained after the survey is generally a function of the surface density of sources and/or of receivers. In particular, a significant number of receivers have to be put in place in the ground to obtain an image of good quality. This is in particular the case when a three-dimensional image is required.

The quality of the obtained image is also function of the coupling between the sensor and the ground. In some areas of interest, such as grasslands, forests, etc., it is easy to peg the seismic receiver in the ground and to obtain an efficient coupling with it, due to the presence of a layer of topsoil. In other areas, such as mountains, rocky areas such as deserts, and areas presenting a rough topography, it is difficult to obtain an efficient mechanical coupling with the ground.

### SUMMARY

One aim of the invention is to provide a resistant sensor device, in particular for conducting a seismic survey which allows an efficient mechanical coupling with the ground, especially when the sensor device is dropped or laid from/by a deployment platform.

To this aim, the subject-matter of the invention is a sensor device for geophysical measurement intended to be disposed on a surface of a ground, the sensor device comprising:
a sealed enclosure delimiting an internal volume, at least a part of the enclosure being deformable into at least one stable configuration in which a surface of the enclosure is deformed by a surface of the ground against which the surface of the enclosure is in contact, the enclosure being at least partially filled with a material able to be deformed by the surface of the ground,
at least one geophysical sensor, said geophysical sensor being arranged inside the enclosure, and fully surrounded by the material or being fixed or printed on the surface of the enclosure intended to be in contact with the surface of the ground.

The sensor device according to the invention may comprise one or more of the following features, taken solely or according to any potential technical combination:
the geophysical sensor is formed by at least one microelectromechanical system fixed or printed on the surface of the enclosure intended to be in contact with the surface of the ground;
the sensor comprises a transmitting and/or receiving unit arranged inside the enclosure;
the sensor comprises an antenna connected to the transmitting and/or receiving unit, the antenna being arranged through the enclosure ;
the sensor comprises a battery and/or a data storing unit both connected to the geophysical sensor and both arranged inside the enclosure:
the sensor comprises a holding device fixed to the enclosure ;
the enclosure is a closed pocket, in particular made of a film or a fabric;
the geophysical sensor is chosen among a geophone or an accelerometer;
the sensor comprises a slowing device intended to slow the sensor device when dropped at a predetermined height from an airborne platform;
at least a part of the enclosure and/or at least a part of the geophysical sensor is biodegradable; and
the at least a part of the enclosure is reversibly deformable into a plurality of stable configurations in which the surface of the enclosure is deformed by the surface of the ground against which the surface of the enclosure is in contact.

The invention also concerns an assembly comprising:
at least a sensor device for geophysical measurement as described above, and
at least one deployment platform adapted to carry the sensor device, the deployment platform being in particular an unmanned aerial vehicle or a unmanned ground vehicle.

The assembly may comprise the following optional feature: the sensor device is removably fixed to the deployment platform.

The invention also deals with a method for deploying a sensor device as described above, using a deployment platform, the method comprising:
positioning the deployment platform above a ground target, and
setting up the sensor device on the ground.

According to a specific embodiment, the setting up step comprises dropping the sensor device from the deployment platform at a predetermined height or laying the sensor device on the surface of the ground with the deployment platform.

The invention further relates to a method for retrieving a sensor device as described above, using a retrieving platform the sensor device being disposed on the surface of the ground, the method comprising:
positioning the retrieving platform above the sensor device,
fixing the sensor device to the retrieving platform, and
carrying the sensor device.

### BRIEF DESCRIPTION OF THE DRAWINGS

The invention will be better understood, based on the following description, given solely as an example, and made in reference to the following drawings, in which:

FIG. 1 is a schematic view of a region of interest with an assembly for conducting a seismic survey,

FIG. 2 is a schematic view of a sensor device according to a first embodiment,

FIG. 3 is a partially schematic view of the sensor device of FIG. 2 with a deployment/retrieving platform,

FIG. 4 is a schematic view of the sensor device of FIG. 1 dropped on the ground of the area of interest,

FIG. 5 is a schematic view of a sensor device according to another embodiment, and

FIG. 6 is a schematic view of a sensor device according to another embodiment.

### DETAILED DESCRIPTION

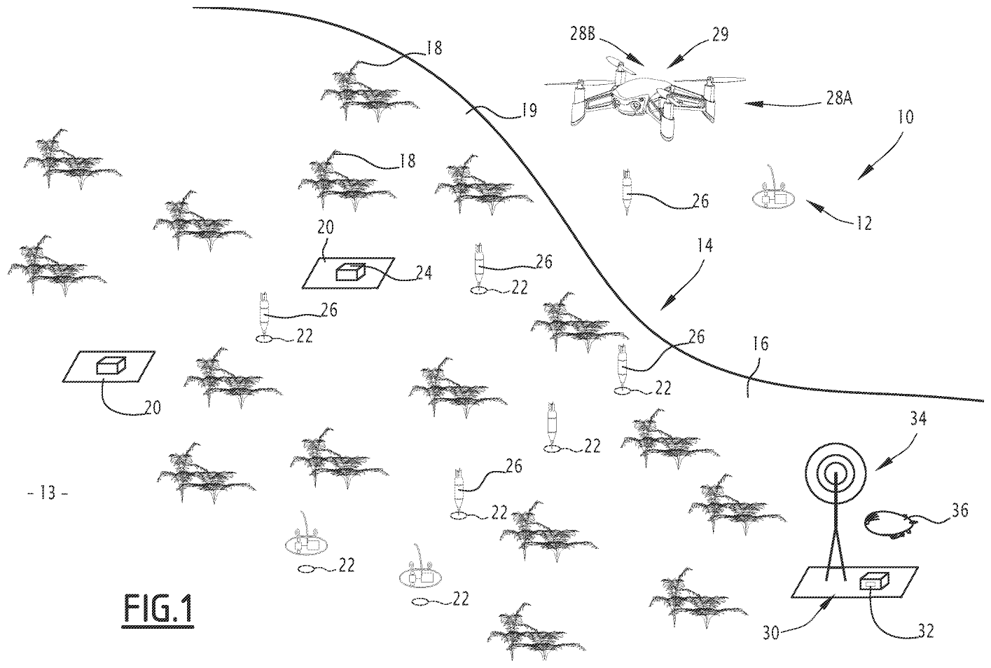

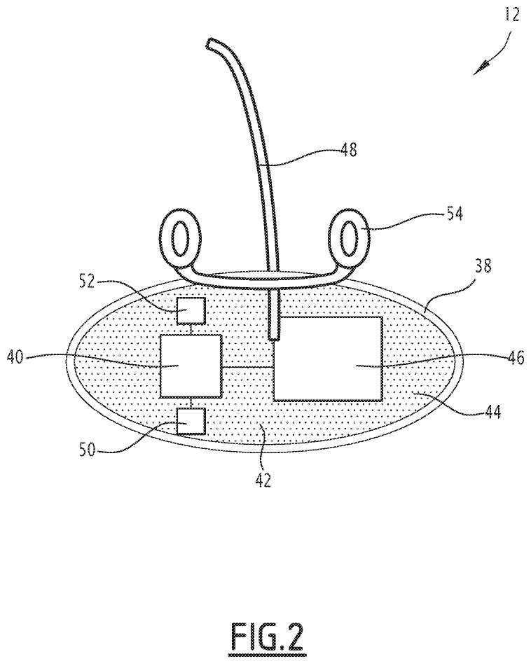

A ground assembly 10 and a sensor device 12 according to the invention are represented respectively in FIGS. 1 and 2.

The ground survey assembly 10 is for carrying out a geophysical survey of an onshore region of interest 14.

The ground assembly 10 is used in particular to collect geophysical data and measurements for determining the physical properties of the subsurface located in the region of interest 14 and/or for building an image of the geology of the subsurface, preferably a tridimensional image of the subsurface.

The region of interest 14 is for example a region having an uneven terrain 16. The uneven terrain 16 in particular comprises hills, mountains, cliffs or any type of rugged terrain. The region of interest 14 is for example located on foothills which are difficult to access. The region of interest 14 comprises in particular rocky areas with for examples rocky outcrops and only a thin layer of topsoil or no layer of topsoil.

The region of interest 14 may comprise vegetation 18. The vegetation 18 is for example a forest, in particular a tropical forest. It comprises a high density of vegetation, for example trees forming a canopy which covers a majority of the surface of the ground 19 in the region of interest 14.

In a variant, the region of interest 14 is a non-forest environment, for example a rocky desert or any open area.

The subsurface located below the ground comprises layers of geological formation and potentially oil and gas reservoirs.

In the region of interest 14, the vegetation 18 defines a plurality of natural and/or artificial clearings 20 offering an access to the ground through openings in the canopy. The vegetation 18 in the region of interest 14 also defines sky holes 22 in the canopy.

The clearings 20 are spread in the region of interest 14, at a distance generally comprised between 100 m and 500 m, preferentially around 300 m, taken along the line of sight between two adjacent clearings 20.

The clearings 20 generally have a surface area greater than 25 m², at the ground level and generally greater than 900 m² at the top of the canopy. Seismic sources 24 can be put in place in the clearings 20.

A clearing 20 is for example defined in a OGP Standard “OGP-Helicopter Guideline for Land Seismic and Helirig operations—Report 420 version 1.1 June 2013

Sky holes 22 are generally natural. They advantageously form a vertical “light tube” between the canopy and the ground.

For example, the sky holes 22 have a minimal surface area greater than 1 m², preferentially greater than 3 m², and comprised for example between 3 m² and 20 m².

For example, the sky holes 22 are formed by rocky outcrops.

The sensor device 12 according to the invention is able to be dropped in each sky hole 22, as will be described later.

At least a sky hole 22 has a surface area which is smaller than the surface area of the clearings 20.

The ground survey assembly 10 comprises a plurality of sources 24, able to generate a geophysical stimulus in the ground, in particular a seismic signal.

The ground survey assembly 10 further comprises a plurality of sensors 12 and/or, 26 spread in the region of interest 14 to collect geophysical data arising from the seismic signal generated by the sources 20.

The plurality of sensors comprises a plurality of probes 26 presenting a dart shape. Such kinds of probes are for example those disclosed in WO2018/224620.

The plurality of sensors comprises a plurality of sensors devices 12 according to the invention.

According to a specific embodiment, the plurality of sensors may comprise only a plurality of sensor devices 12 according to the invention.

In reference to FIG. 1, the ground survey assembly 10 further comprises a fleet of deployment platforms 28A, able to fly above the region of interest 14 or move on the region of interest 14 to carry each sensor 12, 26 above its point of installation.

The deployment platform 28A is preferably an unmanned airborne vehicle (UAV) 29.

Then, the ground assembly 10 may comprise, for each deployment platform 28A, a launching unit able to separate each sensor 12, 26 carried by the deployment platform 28A to let the sensor 12, 26 free fall to its installation point in the ground.

In variant, the deployment platform 28A is an airplane or an airship.

Each deployment platform 28A may carry at least one probe 26 presenting a dart shape and/or at least one sensor device 12 according to the invention.

In an embodiment, the fleet of deployment platforms 28A comprises a first group of deployment platforms 28A carrying at least one probe 26 presenting a dart shape, and a second group of deployment platforms 28A carrying at least one sensor device 12 according to the invention.

In another embodiment, the fleet of deployment platforms 28A comprises only one group of deployment platforms 28A carrying only at least one sensor device 12 according to the invention.

Each sensor device 12 is laid onto the ground or dropped to the ground to sense in particular the seismic signals resulting from interactions of the seismic stimulus generated by a source 24 with the geology of the subsurface 13.

The total density of sensor devices 12 and probes 26 is comprised for example between 10 probes 26/sensor devices 12 per km² and 1000 probes 26/sensor devices 12 per km², in particular between 300 probes 26/sensor devices 12 per km² and 500 probes 26/sensor devices 12 per km², notably 400 probes 26/sensor devices 12 per km².

The ground survey assembly 10 further comprises at least a base 30, comprising at least a collection and/or analysis unit 32 and a telecommunication system 34 able to transfer data measured by the sensors 12, 26 to the collection and/or analysis unit 32, and from the collection and/or analysis unit 32 to an external station (not shown).

The base 30 advantageously comprises a helipad, night facilities for crews, and/or antenna for collecting data. It is used for management of the take-off and landing. It may be used for first aid (e.g. medevac).

The external station may be located at a main camp (not shown). The main camp advantageously comprises facilities for collecting data, as well as a main computing unit, and/or a control center.

Advantageously, the ground survey assembly 10 comprises at least an additional airborne platform 36 such as a helicopter, an airship, able to fly over the vegetation to carry the sources 24 in the clearings 20.

Each seismic source 24 is able to generate a controlled seismic energy generating a geophysical stimulus, in particular a seismic signal in the ground.

The source 24 for example may comprise an explosive, in particular dynamite, able to generate the geophysical stimulus.

The source 24 is inserted in a hole drilled into the ground, for example at a depth comprised between 0 meter and 100 meters, preferably between 5 meters and 80 meters.

In a variant, the source 24 comprises a mechanical device such as a hammer, a vibrator or an airgun.

The density of sources 24 locations laid in the region of interest 14 is generally comprised between 10 source locations per km² and 100 source locations per km². Each source location can comprise one or more source 24.

Each source 24 is preferably arranged in a clearing 20. The source 24 is generally brought to the clearing 20 by the additional airborne platform 36. It can be put in place by an unmanned ground vehicle, such as a semi-automatic drilling platform.

The sensor device 12 according to the invention is schematically represented in FIG. 2.

The sensor device 12 comprises a sealed enclosure 38 and a geophysical sensor 40 arranged inside the enclosure 38.

The enclosure 38 delimits an internal volume 42.

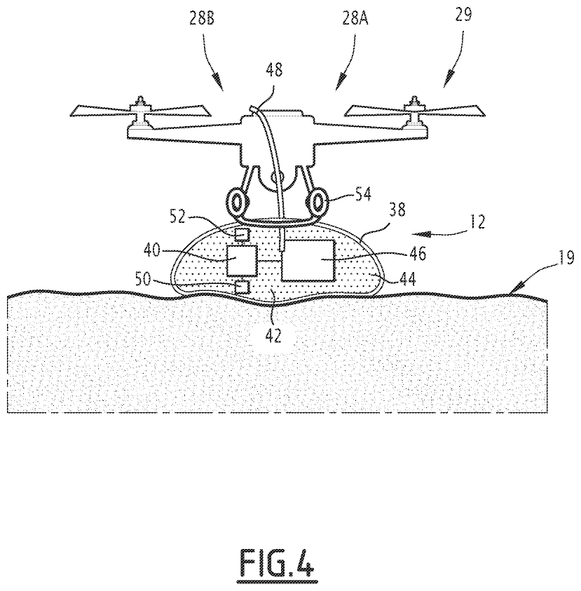

According to the invention, at least a part of the enclosure 38 is deformable into at least one stable configuration in which a surface of the enclosure 38 is deformed by a surface of the ground 19 against which the surface of the enclosure 38 is in contact, as represented in FIG. 4.

In other words, the surface of the enclosure 38 adopts a shape substantially corresponding to the shape of the surface of the ground 19 against which the surface of the enclosure 38 is in contact.

By “substantially corresponding”, it means that the shape of the enclosure 38 does not strictly match the shape of the surface of the ground 19 since the shape of the surface of the enclosure 38 depends of the elasticity of the material of the enclosure 38, the density and the repartition of the material 44 inside the enclosure 38, the wavelength of the irregularities of the ground 19, etc.

Advantageously, the at least a part of the enclosure 38 is reversibly deformable into a plurality of stable configurations in which the surface of the enclosure 38 is deformed by the surface of the ground 19 against which the surface of the enclosure 38 is in contact.

This is particularly advantageous since the sensor 12 may be used several times in various locations of the ground 19.

The enclosure 38 is for example a closed pocket.

At least a part of the enclosure 38 is biodegradable or chemically biodegradable.

By “biodegradable”, it is meant that the enclosure 38 is made of a material which is able to be mineralized by soil microorganisms and or by air microorganisms. For example, a biodegradable material is a material in which more than 90% of the material is converted into carbon dioxide and water by the actions of microorganisms within two years, preferably within one year, more preferably within six months.

Biodegradability can be measured for example according to standard ASTM D5988-12 whose title is “Standard test methods for determining aerobic biodegradation of plastic materials in soil”.

By “chemically degradable”, it is meant that the enclosure 38 is made of a material which is able to be mineralized by chemical reactions with components of the soil and/or with light, in particular with UV light. For example, a chemically degradable material is a material in which more than 90% of the material loses its structure within two years, preferably within one year, more preferably within six months.

Advantageously, the biodegradable material and/or chemically degradable material is degraded in less than within 2 years, preferably within one year, more preferably within 6 months after the contact of the probe 12 with the ground.

Preferably, the enclosure 38 is made of biodegradable plastic. Biodegradable plastics are for example components which are derived from renewable raw materials.

Examples of biodegradable plastics are aliphatic polyesters, such as polyhydroxyalkanoates (PHA), like poly-3-hydroxybutyrate (PHB), polyhydroxyvalerate (PHV), and polyhydroxyhexanoate (PHH). Other examples are polylactic acid (PLA), polybutenesuccinate (PBS), or polycaprolactone (PCL).

Preferably, the enclosure 38 is made of a film, in particular a film of biodegradable material, such as a film of biodegradable plastic. Alternatively, the enclosure 38 is made of fabric or leather.

The enclosure 38 is at least partially filled with a material 44 able to be deformed by the surface of the ground 19. This allows the enclosure 38 to follow the unevenness of the ground.

The material 44 is for example a gel, a thixotropic material and/or a granular material.

The material 44 is able to deform by flow when it is submitted to a deformation force, such as when it contacts a surface after a fall.

Once deformed to the shape of the surface, the material 44 is able to maintain its shape without significant flow.

Preferably, the material 44 has a density higher than 1300 kg/m³. For example, the material 44 is sand.

The geophysical sensor 40 is fully surrounded by the material 44 in all the stable configurations of the sealed enclosure 38.

This ensures a good mechanical coupling of the geophysical sensor 40 with the ground.

The geophysical sensor 40 is chosen among a geophone or an accelerometer. For example, the geophysical sensor 40 is a microelectromechanical system (MEMS) sensor.

The geophysical sensor 40 may comprise three geophones.

Each geophysical sensor 40 is able to sense a physical quantity, in particular a ground movement and to convert it into a signal which may be recorded.

The sensor device 12 further comprises a transmitting and/or receiving unit 46 arranged inside the enclosure 38.

The transmitting and/or receiving unit 46 is connected to the geophysical sensor 40.

The transmitting and/or receiving unit 46 is configured to send and/or receive data information to and/or from a deployment platform 28A, in particular to and/or from the deployment platforms 28A which carried the sensor device 12 with said transmitting and/or receiving unit 46.

In variant or in addition, the transmitting and/or receiving unit 46 may also configured to send and/or receive data information to and/or from transmitting and/or receiving units or collecting unit 32 disposed in the region of interest 14, for example in a base camp of in a main base camp.

The sensor device 12 may comprise an antenna 48 connected to the transmitting and/or receiving unit 46.

As represented in FIG. 2, the antenna 48 may be arranged through the enclosure 38.

In a variant, the antenna 48 is comprised inside the enclosure 38. The antenna 48 is then not visible from outside of the enclosure 38.

The sensor device 12 may comprise a battery 50 arranged in the enclosure 38 intended to provide power to the geophysical sensor 40 and/or to the transmitting and/or receiving unit 46.

Advantageously, the battery 50 is biodegradable.

In one embodiment, the sensor device 12 comprises a data storing unit 52 such a hard disk or a flash disk, arranged inside the enclosure 38. The data storing unit 52 may be used as main memory unit to record data measured by the geophysical sensor 40 or may be used as a backup memory in case of a loss of communication between the transmitting and/or receiving unit 46 and the transmitting and/or receiving unit(s) disposed in the region of interest 14.

The sensor device 12 may comprise a holding device 54 fixed to the enclosure 38.

The holding device 54 is for example a hook or any suitable device able to removably fix the sensor device 12 to the deployment platforms 28A, in such a way that the sensor device 12 can be detached or attached from the deployment platform 28A.

The deployment platform 28A comprises a complementary holding device intended to interact with the holding device 54 of the sensor device 12 to ensure a good removable fastening of the sensor device 12 to the deployment platform 28A.

The holding device 54 is robust since it is solicited each time the sensor device 12 is laid on the ground and each time the sensor device 12 is retrieved by a retrieving platform 28B (in case it is retrieved).

The retrieving platform 28B is for example an airborne platform.

In the present embodiment, the retrieving platform 28B and the deployment platform 28A are identical. It means that the retrieving platform 28B and the deployment platform 28A are both an airborne platform, such as an unmanned airborne vehicle. It can be the same airborne platform or a similar airborne platform.

A method for deploying a sensor device 12 will now be described.

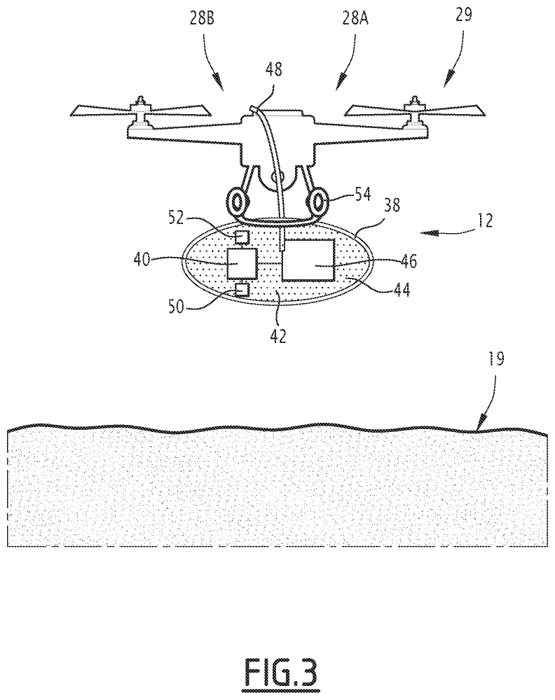

The method comprises a step of positioning the deployment platform 28A above a ground target in the region of interest 14 (FIG. 3). The ground target is typically a sky hole 22.

For example, the positioning is made using a positioning unit embedded in the deployment platform 28A.

Then, the method comprises setting up the sensor device 12 on the ground.

According to an embodiment, the setting up step may comprise a step for dropping the sensor device 12 from the deployment platform 28A. Then, the sensor device 12 falls from a predetermined height from the deployment platform 28A and its speed may be reduced using the slowing device 56. The sensor device 12 bumps the ground and the enclosure 38 adopts a shape corresponding to the shape of the surface of the ground 19 against which the surface of the enclosure 38 is in contact.

In a variant, the setting up step comprises laying the sensor device 12 on the surface of the ground 19 with the deployment platform 28A. In a forest environment, laying the sensor device 12 on the ground is feasible only if the sky hole 22 is sufficiently large for the deployment platform 28A to go through the sky hole 22 and to land on the ground.

Laying the sensor device 12 also allows increasing the lifetime of the sensor device 12 by limiting the shocks with the ground which could damage the enclosure 38 of the sensor device 12.

A method for retrieving a sensor device 12 using a retrieving platform 28B will be described.

The sensor device 12 is disposed on the surface of the ground 19 of the region of interest 14.

The method comprises positioning the retrieving platform 28B above the sensor device 12. For example, as mentioned above, if an embodiment wherein the deployment platform 28A and the retrieving platform 28B are identical, the positioning unit of the deployment platform 28A may be used.

Then, the method comprises fixing the sensor device 12 to the retrieving platform 28B using the holding device 54.

Finally, the method comprises carrying the sensor device 12 with the retrieving platform 28B. The sensor device 12 may be carried to another place, such as another sky hole 22, of the region of interest 14 for another measurement. In variant, the sensor device 12 is carried to a base camp for maintenance of for retrieved data recorded by the data storing unit 52.

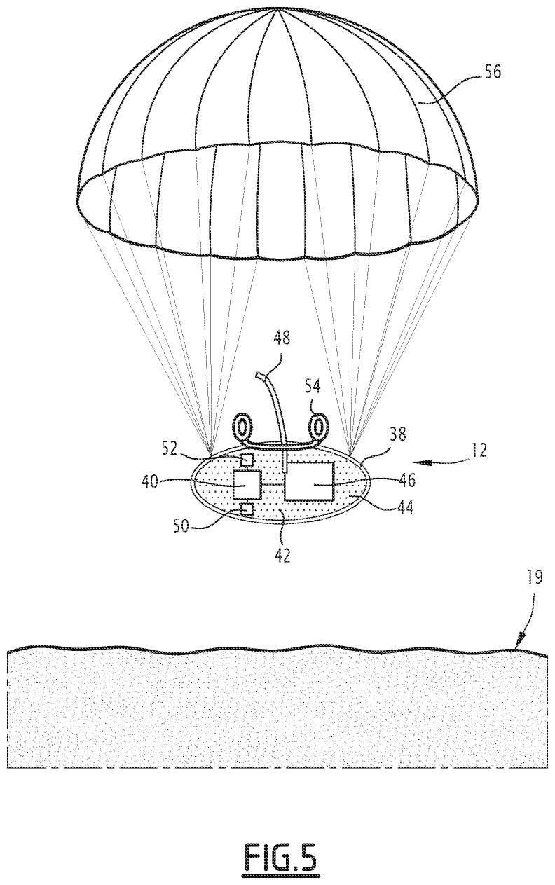

According to an embodiment shown in FIG. 5, the sensor device 12 advantageously comprises a slowing device 56 intended to slow the sensor device 12 when dropped at a predetermined height from the deployment platform 28A.

The slowing device 56 is for example a parachute. The parachute is typically embedded in the enclosure 38 and deployed during the drop from the airborne platform 28.

According to an embodiment, the deployment platform 28A and/or the retrieving platform 28B is a ground vehicle, for example an unmanned ground vehicle.

According to an embodiment, the deployment platform 28A and the retrieving platform are two different platforms. For example, the deployment platform 28A is an unmanned airborne vehicle and the retrieving platform 28B is an unmanned ground vehicle.

In another variant, the sensor device 12 is manually deployed and/or manually retrieved by an operator.

In another variant, only the geophysical sensor 40 is arranged inside the enclosure 38. Other electronic elements such as the transmitting and/or receiving unit 46 and/or the battery 50 and/or the data storing unit 52 are arranged outside the enclosure 38. Such elements may be removably connected to the geophysical sensor 40, that is to say that only such elements may be retrieved after the measurements are completed.

A least a part of these elements may be arranged inside the deployment or retrieving platforms 28A, 28B.

In a variant, the transmitting and/or receiving unit 46 of the deployment platform 28A or of the retrieving platform 28B may be used to transfer the data recorded by the sensor device 12, advantageously with a time delay.

In another variant, the sensor device 12 is rigidly fixed to the deployment platform 28A/retrieving platform 28B. In an embodiment wherein the deployment and the retrieving platforms 28A, 28B are an unmanned airborne vehicle 29. The unmanned airborne vehicle 29 lands on the ground 19 and stays on the ground 19 during the measurement. Then, it takes off with the sensor device 12 after the measurement is completed.

This is particularly advantageous since the weight of the deployment platform 28A (UAV) pushing on the enclosure 38 allows improving the coupling of the sensor device 12 with the ground 19.

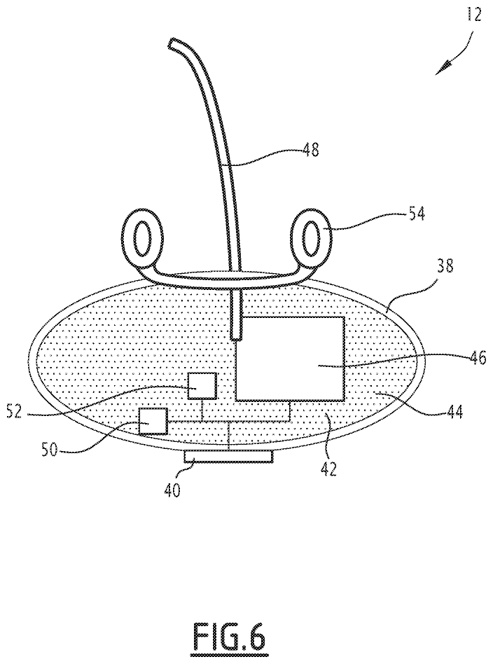

In another variant (FIG. 6), the geophysical sensor 40 is formed by at least one microelectromechanical system (MEMS) fixed or printed on the surface of the enclosure 38 intended to be in contact with the surface of the ground 19.

For example, the geophysical sensor 40 comprises a grid of MEMS, such as a grid comprising three*three MEMS.

A good signal to noise ratio may be obtained with such kind of geophysical sensor 40 by stacking the signal recorded by each MEMS.

1. A sensor device to carry out geophysical measurements, the sensor device being configured to be disposed on a surface of a ground, the sensor device comprising:
a sealed enclosure delimiting an internal volume, at least a part of the enclosure being deformable into at least one stable configuration in which a contact surface of the enclosure is deformed by a-the surface of the ground against which the contact surface is in contact, the enclosure being at least partially filled with a material configured to be deformed by the surface of the ground,
at least one geophysical sensor, said at least one geophysical sensor being at least one of: arranged inside the enclosure, and being fully surrounded by the material, or being fixed on the contact surface, or being printed on the contact surface.

2. The sensor device according to claim 1, comprising a transmitter and/or receiver arranged inside the enclosure.

3. The sensor device according to claim 2, comprising an antenna connected to the transmitter and/or receiver, the antenna being arranged through the enclosure.

4. The sensor device according to claim 1, comprising a battery and/or a data storage, the battery and/or the data storage being connected to the geophysical sensor and being arranged inside the enclosure.

5. The sensor device according to claim 1, comprising a holder fixed to the enclosure.

6. The sensor device according to claim 1, wherein the enclosure is a closed pocket.

7. The sensor device according to claim 1, wherein the geophysical sensor is a geophone or/and an accelerometer.

8. The sensor device according to claim 1, comprising a device configured to slow the sensor device when the sensor device is dropped at a predetermined height from an airborne platform.

9. The sensor device according to claim 1, wherein at least a region of the enclosure and/or at least a region of the geophysical sensor is biodegradable.

10. The sensor device according to claim 1, wherein the at least a part of the enclosure is reversibly deformable into a plurality of different stable configurations.

11. An assembly comprising:
at least a sensor device according to claim 1, and
at least one deployment platform configured to carry the sensor device.

12. The assembly according to claim 11, wherein the sensor device is removably fixed to the deployment platform.

13. A method for deploying a sensor device, comprising:
providing a deployment platform carrying a sensor device according to claim 1,
positioning the deployment platform above a ground target, and
setting up the sensor device on the ground at the ground target.

14. The method according to claim 13, wherein the setting up of the sensor device comprises dropping the sensor device from the deployment platform at a predetermined height above the ground or comprises laying the sensor device on a surface of the ground with the deployment platform.

15. A method for retrieving a sensor device comprising:
providing a retrieving platform,
providing a sensor device according to claim 1, disposed on a surface of the ground,
positioning the retrieving platform above the sensor device,
fixing the sensor device to the retrieving platform, and
carrying the sensor device with the retrieving platform.

16. The assembly according to claim 11, wherein the deployment platform is an unmanned aerial vehicle or an unmanned ground vehicle.
